(19) United States
(12) Patent Application Publication
(10) Pub. No.: US 2009/0037444 A1
(43) Pub. Date: Feb. 5, 2009

(54) Integrated Systems & Methods For Document Scanning, Storing & Retrieval

(76) Inventor: Tim Stapleton, Long Beach, CA (US)

Correspondence Address: FISH & ASSOCIATES, PC;ROBERT D. FISH, 2603 Main Street, Suite 1050, Irvine, CA, 92614-6232, US

(21) Appl. No.: 12/182,811

(22) Filed: Jul. 30, 2008

Related U.S. Application Data
(60) Provisional application No. 60/953,381, filed on Aug. 1, 2007.

(51) Int. Cl. G06F 17/30

(52) U.S. Cl. 707/100; 707/E17.008

(57) ABSTRACT

A scanning system includes a computer with scanning, OCR, full-text indexing, and retrieval software. The computer is readily connectable to a network and can be controlled through a display and keyboard that is either directly connected to the computer or is connected to the computer through the network. The fully-integrated scanning system is supported by a single source. The software further allows the user to customize file names and folder permissions.

This application claims priority to U.S. provisional application Ser. No. 60/953,381 filed Aug. 1, 2007.

### FIELD OF THE INVENTION

The field of the invention is document management systems (358/403).

### BACKGROUND

It has long been recognized that storing, maintaining, and accessing a large number of documents can be very costly. A law office, for example, may well have tens of thousands of boxes of old documents stored with only minimal accessibility at a cost of hundreds of thousands of dollars per year.

There have been many commercial solutions over the years, beginning perhaps with data scanning services. Such services would typically scan the documents into a database, and then manually or in some other manner associate keywords or other metadata with each of the documents. Essentially, those early services were merely replacing electronic images for the paper copies.

As Optical Character Recognition (OCR) software has become more accurate, data scanning services have begun to provide text versions of the scanned images. The text is sometimes stored separately, but can advantageously be stored along with the image in a .PDF or other text over image format.

It is still further known to index each of the words in a document, and to provide full-text indexed searching capabilities. Microsoft SharePoint Portal Server has provided that capability for many years. There are many other indexing solutions as well, including for example the Hummingbird™ DocsOpen™ software.

One problem with many of the indexing solutions is that they utilize proprietary databases and non-user friendly naming convention to store the documents. In some cases these conventional solutions even use hosted databases, so that the end-users don't even store their own data. These drawbacks are sold to users as benefits, in that users need not be concerned with where or how a document is stored, how it is backed up, and with security.

In actual use, however, users often want to store documents in their own local file structures, using their own naming conventions. The DocsOpen™ software, for example, is currently being superseded by a version that still stores documents in their proprietary data structure, but that points those documents to a user's directory structure, so that the documents can be accessed as if they were included in the user's directory structure. Other software, such as Document Locator™ by ColumbiaSoft™ allow users to store documents however they want within a designated repository. Still further, U.S. Pat. No. 7,171,468 to Yeung et al. (January 2007) teaches systems and methods by which a user can interface with a network-based document management system using a local file system.

During the last decade there have been numerous other sophisticated additions to scan-OCR-index systems as well. For example, US 2007/0016844 to Komamura et al. (publ. January 2007) describes techniques for retrieving documents where relevant location data is missing. US 2006/02154224 to Matusmoto (publ. September 2006) teaches use of time-stamping and certification servers for use in scanning documents. US 2006-0195491 to Nieland et al. (publ. August 2006) teach automatic extraction of metadata from scanned documents. These, and all other extrinsic materials discussed herein, are incorporated by reference in their entirety. Where a definition or use of a term in an incorporated reference is inconsistent or contrary to the definition of that term provided herein, the definition of that term provided herein applies and the definition of that term in the reference does not apply.

One problem with all of these systems, however, is that they are often too complicated for smaller business uses. In the Document Locator™ system, for example, an information technology person needs to purchase and/or designate an existing scanner, and connect it to the system. Scanners are often sold with OCR software, but they need to be integrated with indexing and retrieval software. In either case users that integrate software and hardware from different vendors often find that they cannot receive adequate support to resolve problems; each of the vendors blames the other. There are integrated, turn-key solutions from some of the photocopy manufacturers, (e.g., Fuji Xerox™, Minolta™), but those solutions are overly restrictive as to where and how the image files are stored.

Thus, there is still a need for a fully integrated system of scanner, OCR software, and index and retrieval software, which is readily connectable to an existing user's network without significant technical assistance.

### SUMMARY OF THE INVENTION

Apparatus, systems and methods in which a fully integrated system of scanner, OCR software, and full-text indexing and retrieval software is readily connectable to an existing user's network without significant technical assistance, and that is supported by a single source.

### BRIEF DESCRIPTION OF THE DRAWING

FIG. 1 is a schematic of a preferred embodiment of a claimed system that includes a scanner, and a computer upon which is loaded the OCRing and indexing software.

FIG. 2 is a screen shot of an interface of an Administrative Console of MightyFile™ for managing dispositions.

FIG. 3 is a screen shot of an interface of the Administrative Console of FIG. 2, in this case for managing filename formats.

FIG. 4 is a screen shot of an interface of the Administrative Console of FIG. 2, in this case for managing folder permissions.

FIG. 5 is a screen shot of an interface of the Administrative Console of FIG. 2, in this case for rebuilding the full-text index.

FIG. 6 is a screen shot of an interface of the Administrative Console of FIG. 2, in this case for managing user accounts.

FIG. 7 is a screen shot of an interface of an edit portion of the document management system.

FIG. 8 is a screen shot of an interface of a retrieval portion of the document management system.

FIG. 9 is a screen shot of an interface of a sample results page from a retrieval portion of the document management system.

FIG. 10 is a screen shot of an interface of another sample results page from a retrieval portion of the document management system.

FIG. 11 is a screen shot of a search interface page from a retrieval portion of the document management system.

FIG. 12 is a screen shot of an advanced scanning interface page of the document management system.

FIG. 13 is a screen shot of a simple scanning interface page of the document management system.

### DETAILED DESCRIPTION

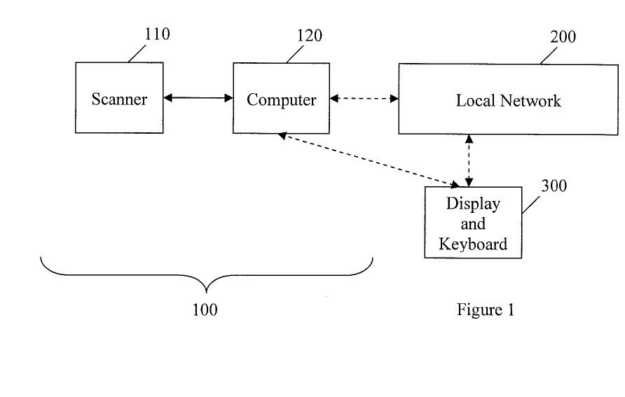

FIG. 1 is a schematic of a preferred embodiment of a claimed system 100 named MightyFile™ that includes a scanner 110, a computer 120 upon which is loaded the MightyFile™ software, which handles administrative functions, controls scanning operations, provide interfaces for storing and accessing documents, and allows end users to install the system merely by adding the system to a local area network. The system 100 is connected to a user network 200, and has a physical user interface 300 (user display and keyboard) that can be connected to the computer either directly or through the network.

At present, the most preferred scanner is an Avision 3850SU, the most preferred OCR software is Omnipage™ 15, and the most preferred indexing and retrieval software is Microsoft™ Indexing Service. Currently referred computers have at least 2 Gigabytes of RAM, at least 2 GHz speed processor, and at least 200 Gigabytes of mass storage.

The system of FIG. 1 is preferably sold as a single item, and all of the components are supported by the seller, distributor, or other sole source.

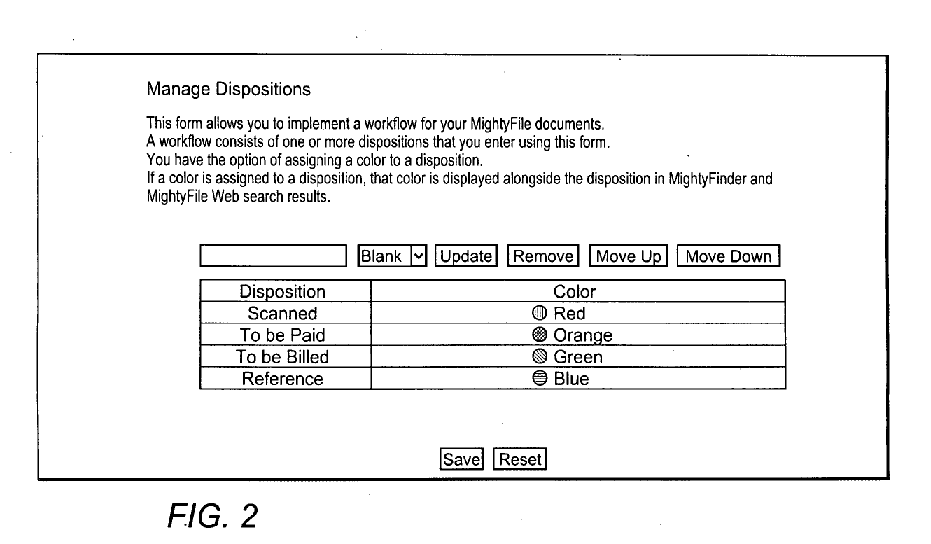

FIG. 2 is a screen shot of an interface of an Administrative Console of MightyFile™ for managing dispositions. In this interface, a user can assign dispositions to a document. Each disposition assigned to a document can also have a corresponding color which is displayed alongside the disposition in MightyFinder and Mightyfile. This feature improves retrievability by allowing a user to search for documents with a particular disposition and readily spot relevant search results using the color assignments.

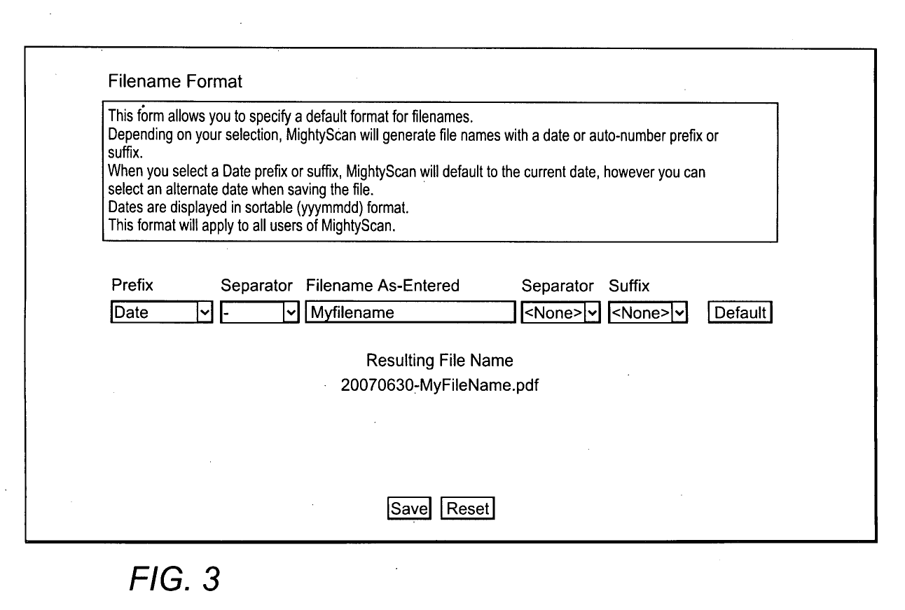

FIG. 3 is a screen shot of an interface of the Administrative Console of FIG. 2, in this case for managing filename formats. This interface allows the user to customize the filename format to the user's organizational needs. The user can specify a format for a filename's prefix or suffix. For example, the user can choose to create filenames with a date in the prefix. Another user may choose to create filenames with an auto-numbered suffix.

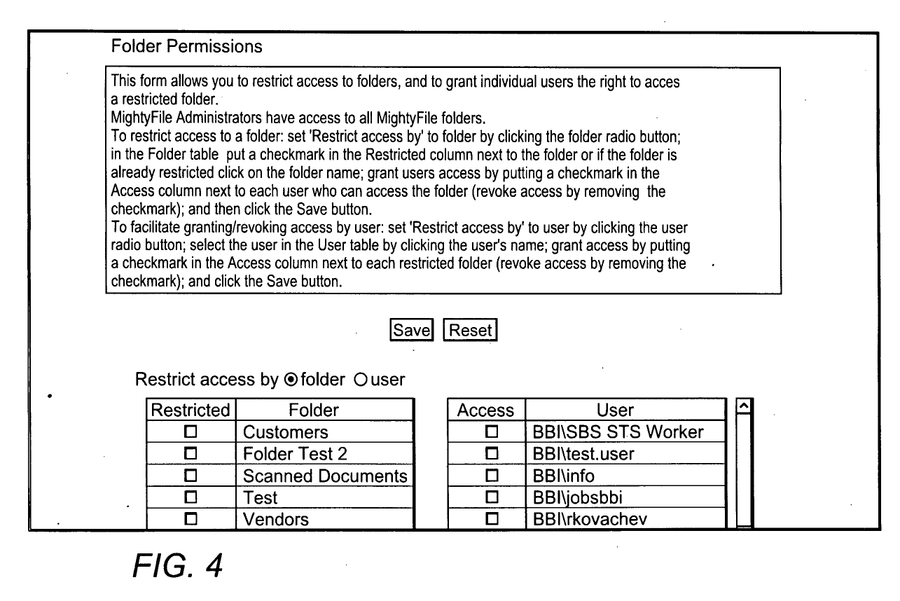

FIG. 4 is a screen shot of an interface of the Administrative Console of FIG. 2, in this case for managing folder permissions. This interface allows an administrator to control access to data, either by folder or by user. For example, an administrator deny or allow general access to a folder by clicking on the radial button “folder” and then checking the box next to folder. Additionally, an administrator can deny or allow access to a folder for a particular user by clicking the radial button “user” and checking the appropriate box next to the user name. The folder permissions feature is particularly helpful in preserving important data and protecting trade secrets and confidential information.

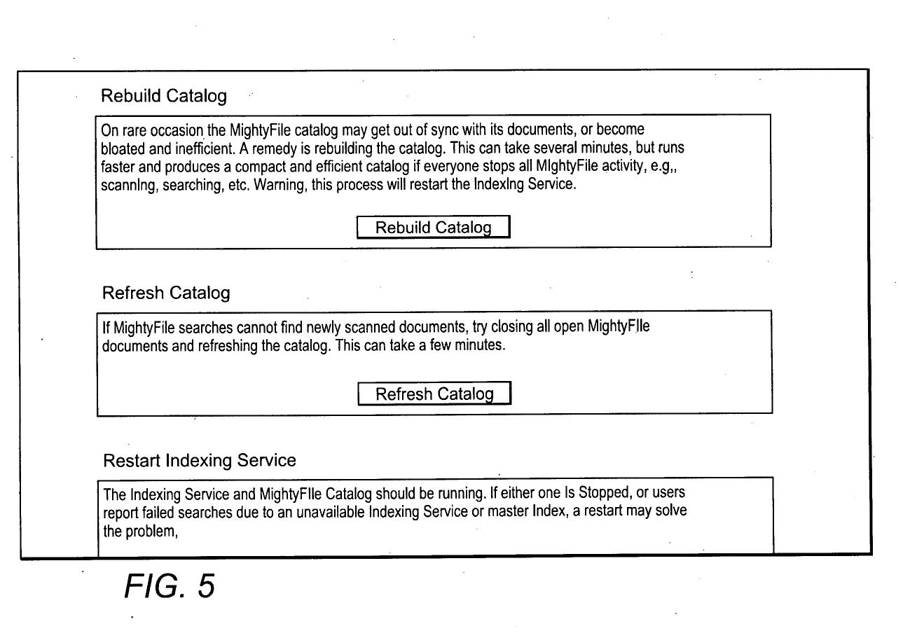

FIG. 5 is a screen shot of an interface of the Administrative Console of FIG. 2, in this case for rebuilding, refreshing, or restarting the full-text index catalog service. The rebuilding feature allows a user to improve catalog efficiency by re-organizing the data into a more compact space and requires a restart of the Index Services. The refresh feature allows a user to refresh the catalog which may help to locate newly scanned documents. The restart index feature may be useful when the catalog service appears to be unavailable or has stopped running.

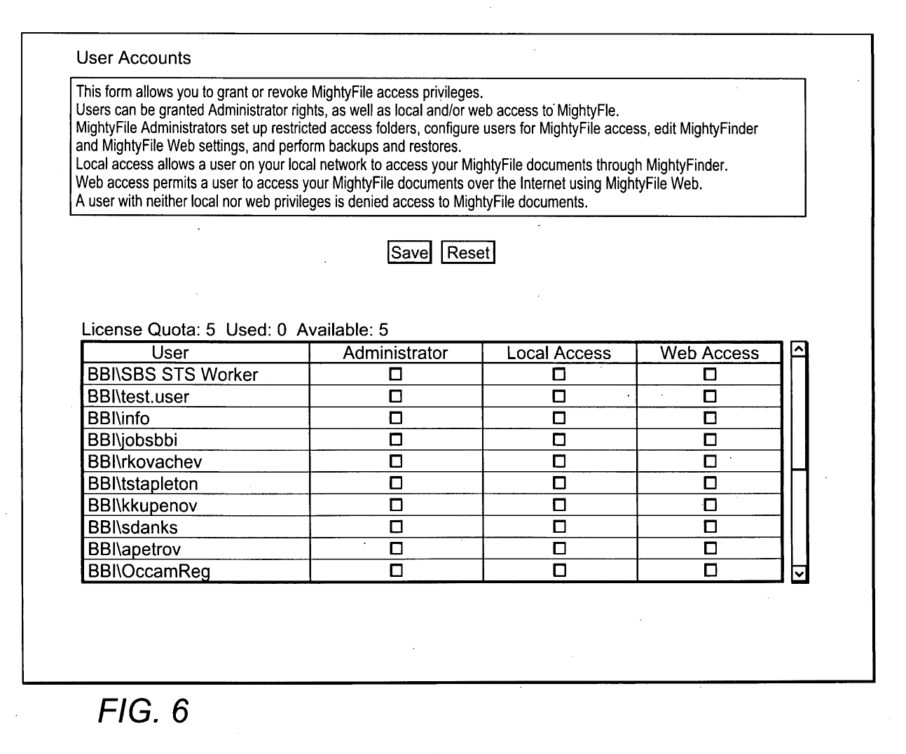

FIG. 6 is a screen shot of an interface of the Administrative Console of FIG. 2, in this case for managing user accounts. A system administrator can set folder permissions using this interface. For example, an administrator can assign a user administrator rights, allow the user to set up restricted access folders, configure users for MightyFile access, edit MightyFinder and MightyFile Web settings, and perform backups and restores. Additionally, an administrator can assign a user Local Access rights, allowing the user to access folders through the local network. Alternatively, the administrator can assign a user with Web Access rights, allowing the user to access folders via an internet connection. One feature of particular interest is that this particular embodiment can inherit folder permissions for the document management system from the operating system.

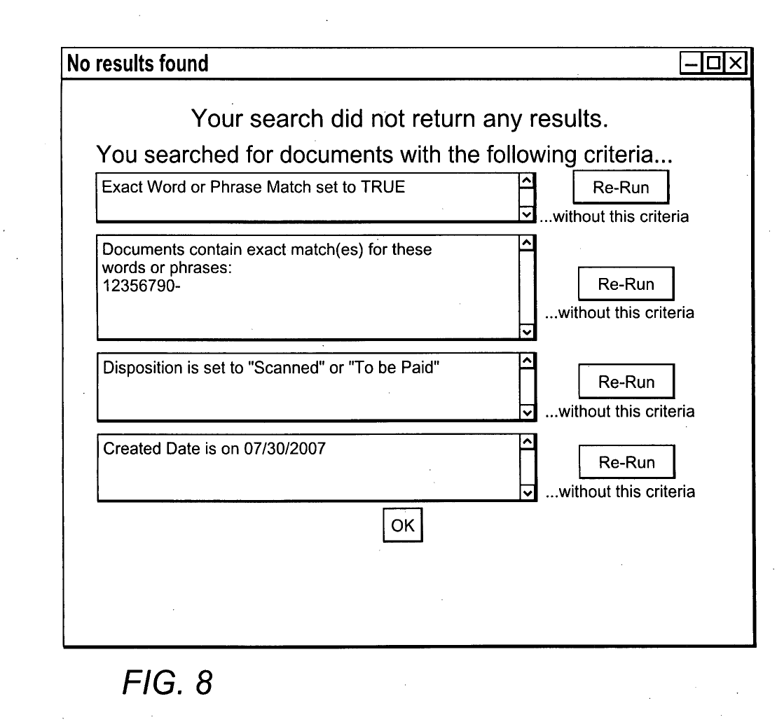

FIG. 7 is a screen shot of an interface of an edit portion of the document management system. Here, the user can change the disposition of the document, and can associate custom metadata to the documents scanned by the system. Also, as one can see from the folder names in FIGS. 4, 6, and 7, the document management system in this example allows ordinary end users to store documents scanned by the system outside of a proprietary data structure, and using user-designated file names.

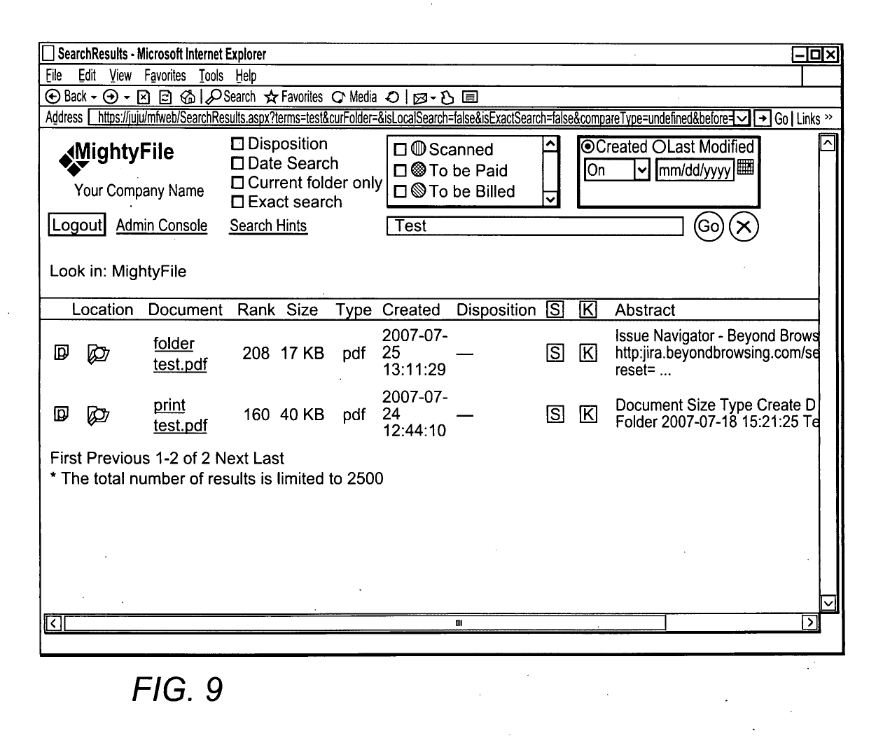

FIG. 8 is a screen shot of an interface of a retrieval portion of the document management system. In one embodiment, the system provides suggested changes to search criteria for null search results. For example, a user can choose to re-run the search with the same search language previously used, but without any exact word restrictions. Alternatively, the user can use the software's suggestion to broaden the search's disposition criterion to include all types of dispositions. This feature allows the user to improve retrievability by providing suggestions to the search logic used.

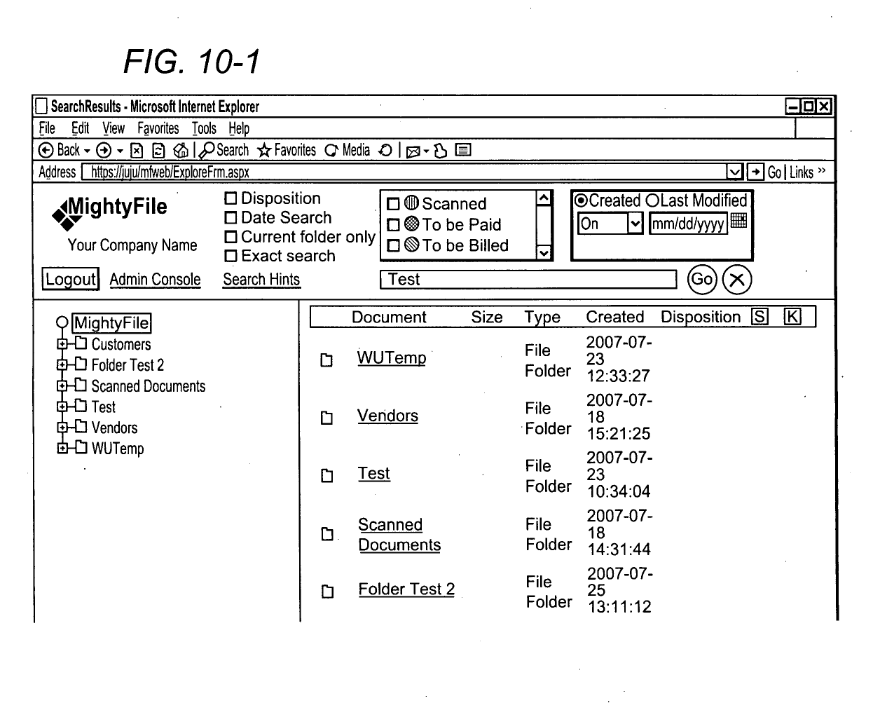

FIG. 9 is a screen shot of an interface of a sample results page from a retrieval portion of the document management system. This interface allows a user to conveniently review search results and retrieve specific documents.

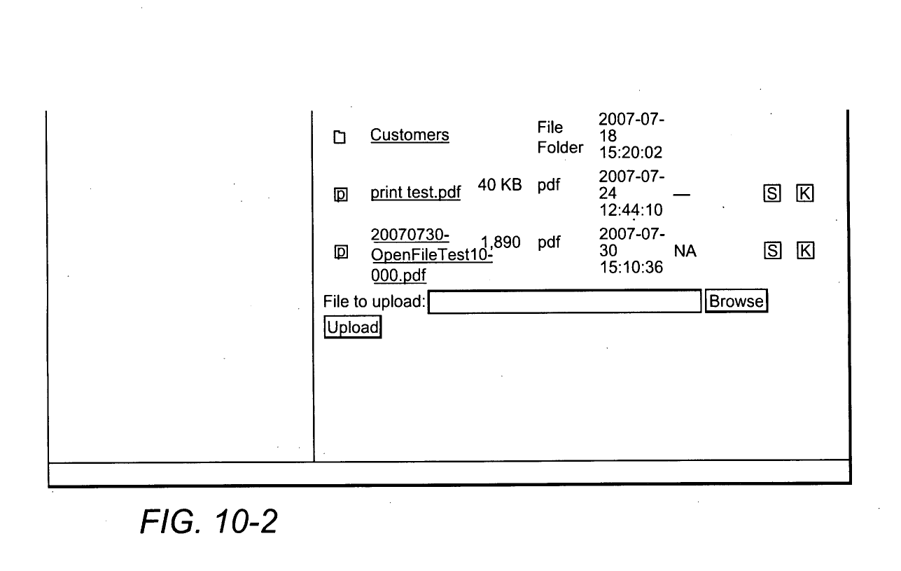

FIG. 10 is a screen shot of an interface of another sample results page from a retrieval portion of the document management system. The page shows eight search results and includes information like the file or folder name, size, date/time of creation, and whether the result is a file or folder.

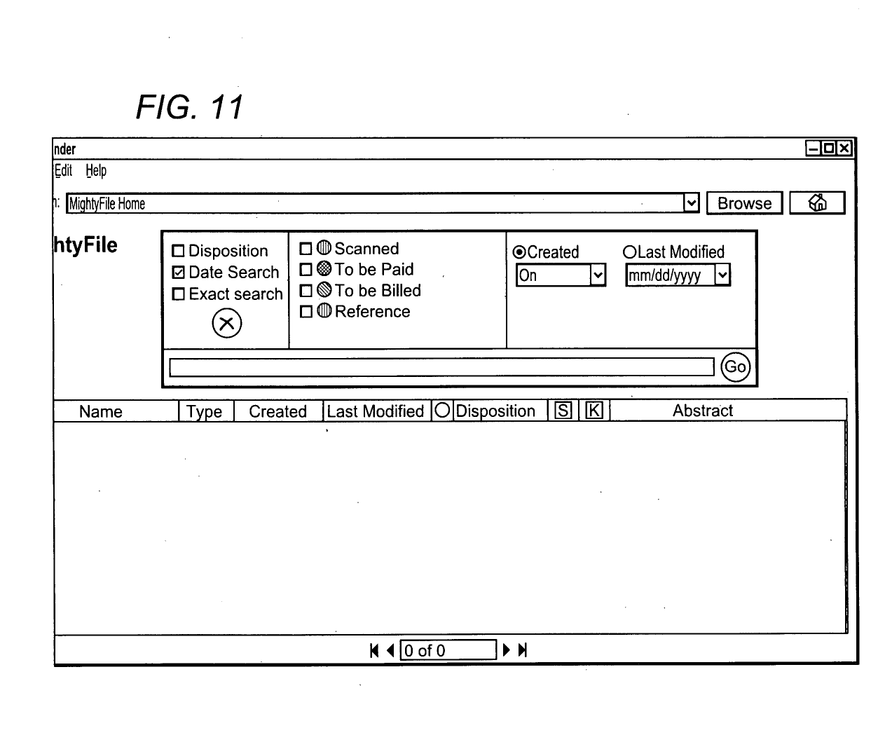

FIG. 11 is a screen shot of a search interface page from a retrieval portion of the document management system. Through this interface, a user can display search results by date created, date modified, disposition, data type, and exact searches.

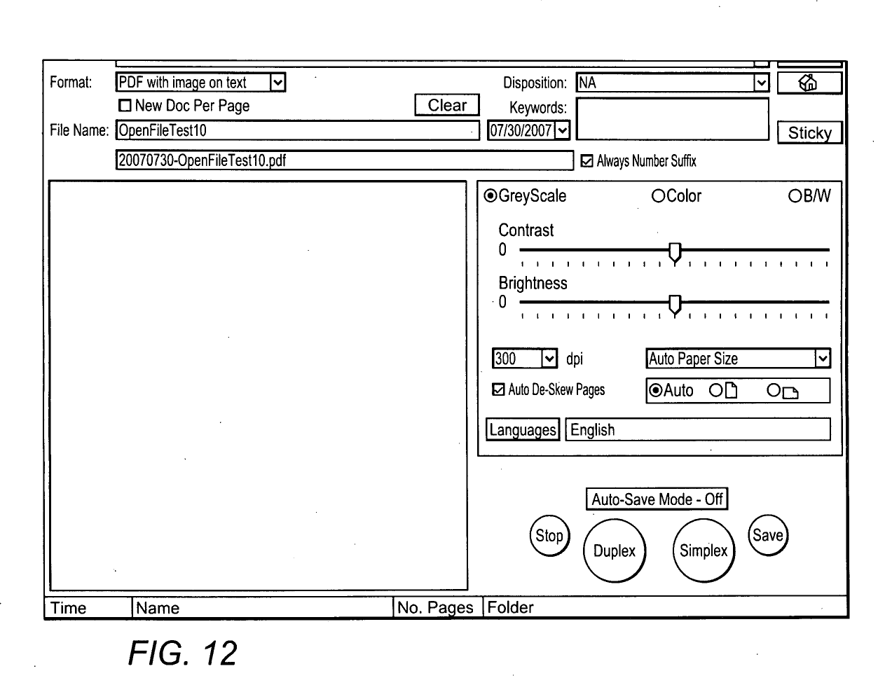

FIG. 12 is a screen shot of an advanced scanning interface page of the document management system. Here, a user can set attributes of the scanned document. For example, the user can set the scanned image to be colored, with particular contrast and brightness values. This interface also allows the user to choose the format type, such as PDF, and file name. This interface can be further used to set keywords associated with the document.

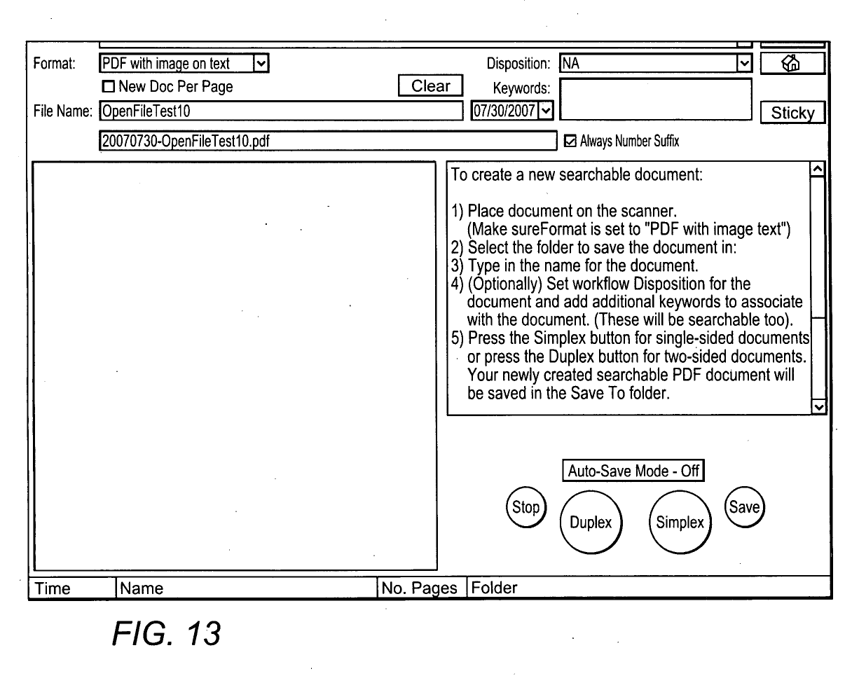

FIG. 13 is a screen shot of a simple scanning interface page of the document management system. This interface shows text that provides instructions for using the scanner. Here, the user can refer to the various steps to operate the scanner.

Thus, specific embodiments and applications of integrated systems & methods for document scanning, storing & retrieval have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of implementing a document management system, comprising:
providing an integrated package that includes a scanner, optical character recognition software, and full-text indexing;
providing an interface that allows ordinary end users to store documents scanned by the system outside of a proprietary data structure, and using user-designated file names; and
providing a single source support for the system.

2. The method of claim 1, further comprising providing suggested changes to search criteria for null search results.

3. The method of claim 1, further comprising inheriting folder permissions for the document management system from an operating system.

4. The method of claim 1, further comprising allowing users to associate custom metadata to the documents scanned by the system.

5. The method of claim 1, further comprising providing a network integration function that allows the end users to install the system merely by adding the system to a local area network.
